(19) United States
(12) Patent Application Publication
(10) Pub. No.: US 2008/0206112 A1
(43) Pub. Date: Aug. 28, 2008

(54) Modular test tube holder

(76) Inventor: Michael Fu, Dayton, NJ (US)

Correspondence Address: J. Gary Mohr, 3 Lisa Lane, Goshen, NY, 10924, US

(21) Appl. No.: 11/977,611

(22) Filed: Oct. 24, 2007

Related U.S. Application Data
(60) Provisional application No. 60/854,280, filed on Oct. 25, 2006.

(51) Int. Cl. B01L 9/06

(52) U.S. Cl. 422/104

(57) ABSTRACT

A modular rack to hold a plurality of specimen containers for performing assays. The modular rack can be increased or decreased in holding capacity by adding or subtracting modules to the rack. The modular rack also has removable webs so that different size specimen containers may be retained by the rack.

### RELATED APPLICATIONS

This application incorporates by reference and claims priority to provisional application No. 60/854,280 filed on Oct. 25, 2006.

### BACKGROUND OF THE INVENTION

Present specimen holding racks are usually of a solid structure that can not be modified to hold fewer or more specimen containers without having to either get another solid smaller or larger rack to accommodate the amount of specimen containers that are to be used. In addition, the present specimen holding racks do not have removable webbing sections to allow for change in the size of the specimen containers to be used.

### SUMMARY OF THE INVENTION

It is therefore an object of the present invention to provide an improved a rack system for a plurality of specimen containers such that it can be easily reconfigured to allow for holding fewer or additional specimen containers.

Another object of the present invention is to achieve simplification of the entire rack system by having removable webs to accommodate different size specimen containers that may be required to be held by the rack.

The above and other objects are achieved, according to the present invention, by a system for holding a plurality of specimen containers, that is easily decreased or increased in holding capacity as well as accommodate for a change in the size of the specimen containers.

The specimen containers can be inserted into this rack and the rack may be increased without the need of removing the containers already contained in the rack. Further by additions of modules to the rack variations in the size of specimen containers can be accommodated by selection of the proper webs for holding the specimen container, again without the need to remove the specimen containers already retained in the rack.

### BRIEF DESCRIPTION OF THE DRAWINGS

FIG. 1 is a perspective view of the base of the modular rack according to the invention.

FIG. 2 is a perspective view of the side wall of the modular rack according to the invention.

FIG. 3 is a perspective view of an assembled module rack according to the invention.

FIG. 4 is a perspective view of a web of the rack according to the invention.

FIG. 5 is bottom view of the bottom rack of the modular rack having an alternative configuration.

FIG. 6 is a side view of the bottom rack of the modular rack of the FIG. 5 configuration.

FIG. 7 is a top view of the bottom rack of the modular rack of the FIG. 5 configuration.

FIG. 8 is a top view of middle and top rack of the modular rack of the FIG. 5 configuration.

FIG. 9 is a side five of the middle and top rack of the modular rack of the FIG. 5 configuration.

FIG. 10 is a perspective view of an assembled module rack of the FIG. 5 configuration.

### DESCRIPTION OF THE PREFERRED EMBODIMENT

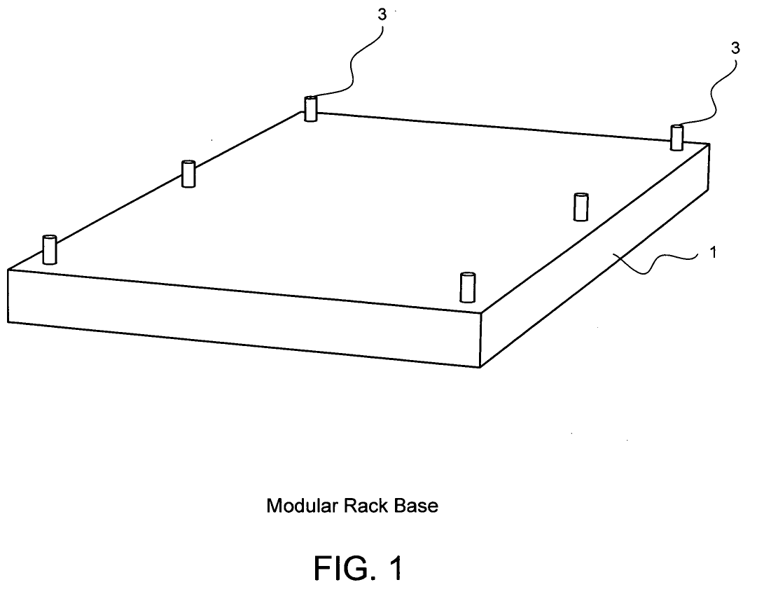

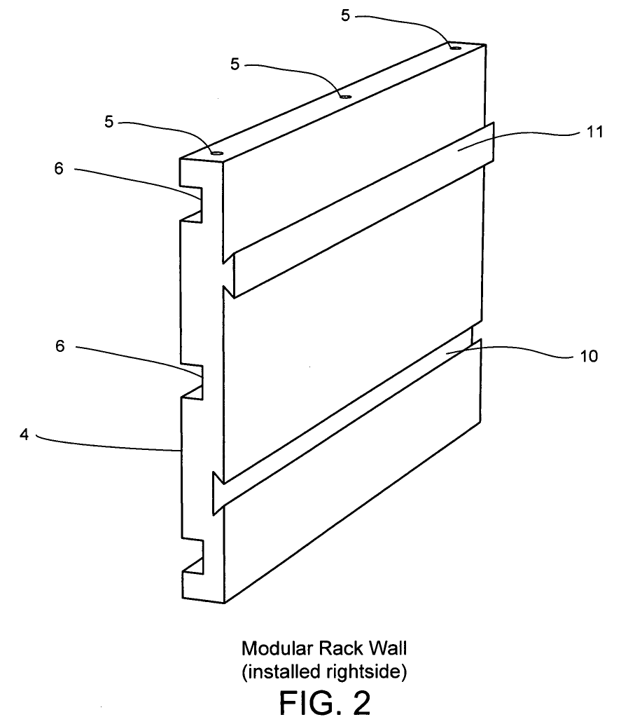

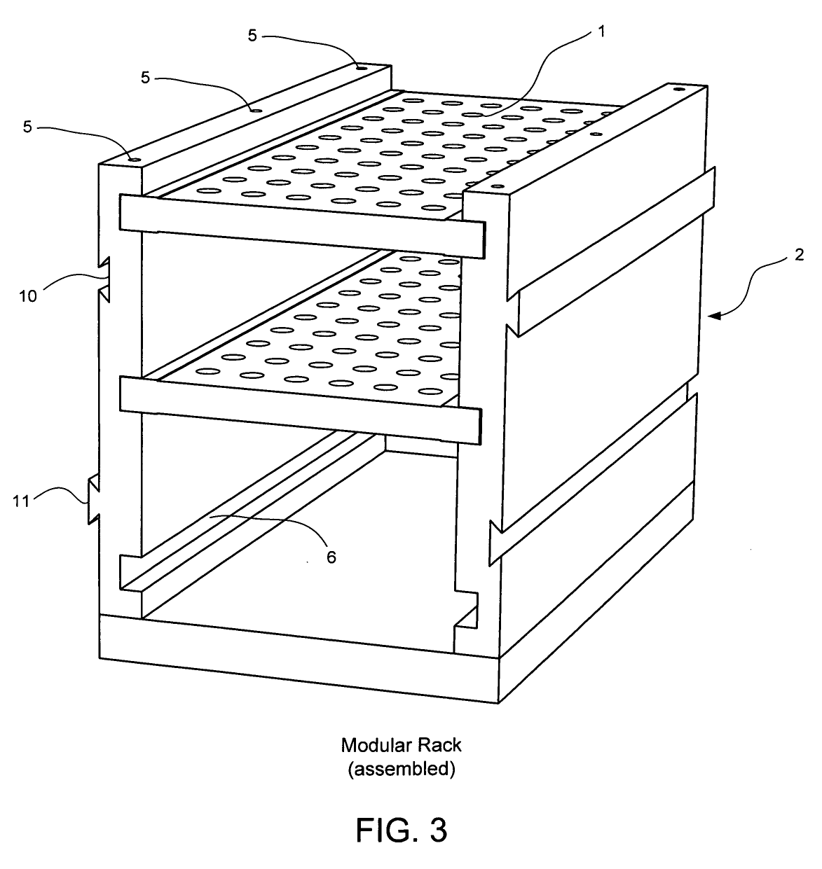

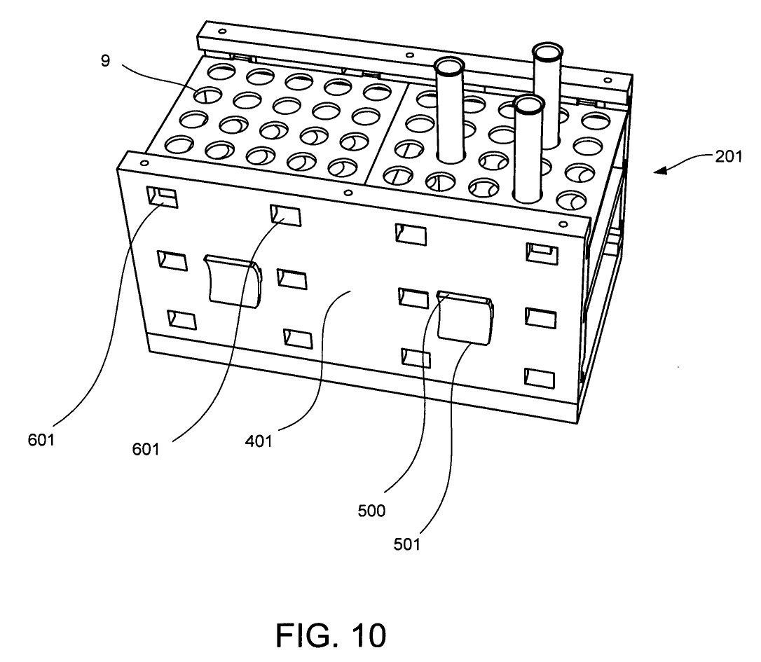

FIGS. 1 and 8 shows the base 1 and 101 of rack 2 and 201 with securing pins 3 for securing side walls 4, through recesses 5. As shown in FIGS. 2 and 10, side wall 4 and 401 has slots 6 and 601 for retaining within rack 2 and 201, removable webs 7 and 701 by means of interlocking tubes or ends 8 or tabs 301 with slots 6 and 601.

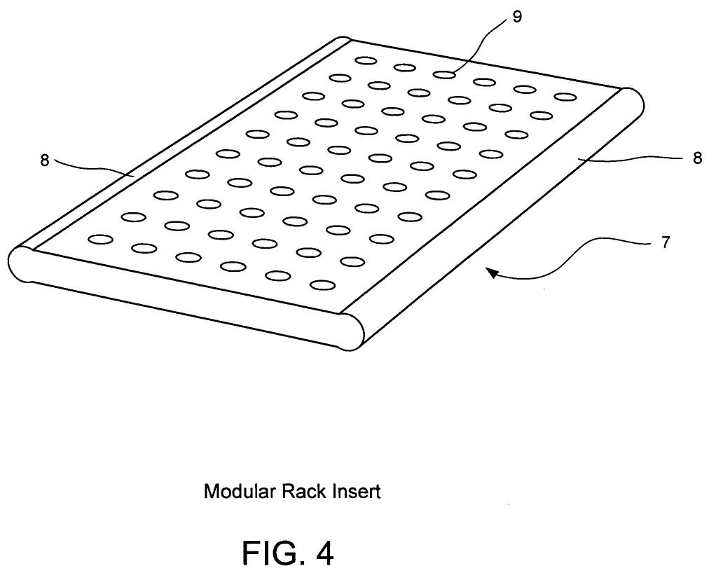

As shown in FIGS. 4 and 8, web 7 and 701 have a plurality of holes 9 that are adapted to secure specimen containers, not shown, within rack 2 and 201. To accommodate different diameter and also length specimen containers the holes 9 in one web 7 and 701 may be of various sizes to mate in different ways with the web 7 and 701 located directly under it.

As shown in FIG. 2 side wall 4 also has recesses 10 and protrusions 11 that may mate with addition walls 4 to increase the capacity of rack 2. Further if the modular rack 2 has more capacity then is needed, one merely has to remove walls 4 to reduce the capacity of the rack 2.

As shown in FIG. 10 side wall 401 also has slots 601 for securing tabs 301 within wall 401. In addition protrusions 500 and 501 maybe be used to add addition racks 201 in a side by side interlocking configuration.

As seen in FIG. 4, since webs 7 may be easily inserted or removed between two walls 4. Capacity or rack 2 due to the number of holes 9 in web 4 may be reduced or increased by insertion of a web 7 with less or more holes 9. Still further should the diameter of the specimen container change or be of multiple size one only has to choose a web 7 that will accommodate them and insert that web 7 into rack 2.

Still further recesses 10 and protrusion 11 may also be used for mounting rack 2 on a wall, not shown, or any other mounting surface that are known in the art.

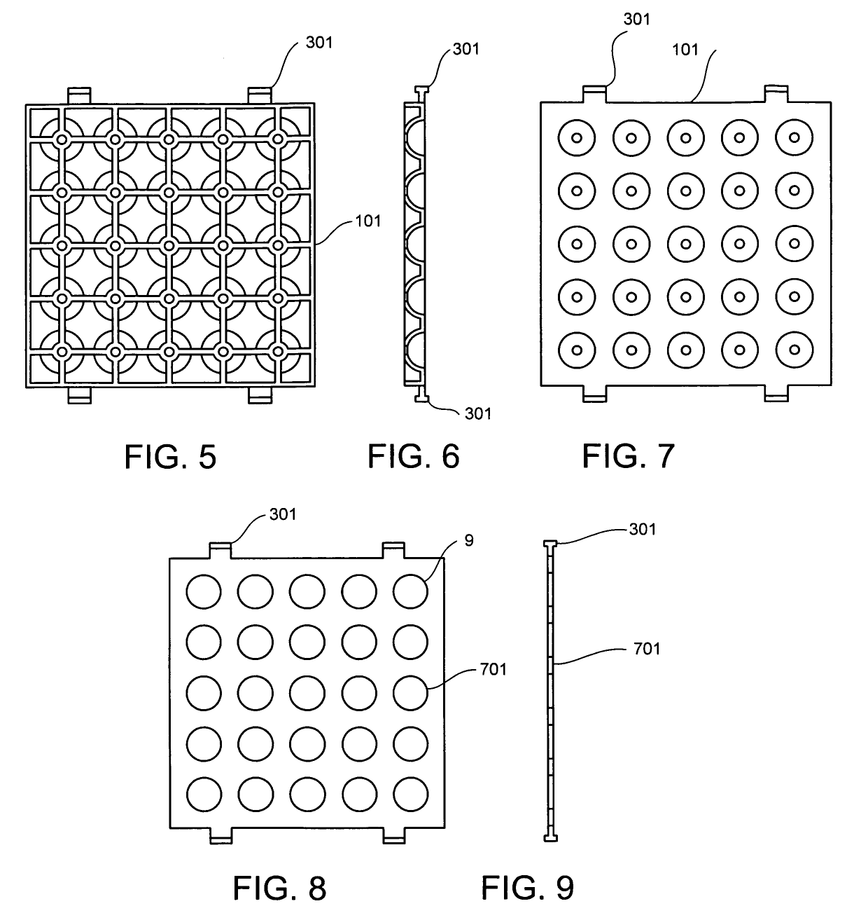

While the recesses 10 and protrusion 11 are of one design in the attached figures, many design alterations may be use to accommodate the combining of the walls 4 and webs 7 within rack 2. This is also the case for pins 3 of base 1. Such additional configurations also being shown in FIGS. 5 through 7.

While the description above refers to particular a embodiment of the present invention, it will be understood that many modifications may be made without departing from the spirit thereof.

The presently disclosed embodiment is therefore to be considered in all respects as illustrative and not restrictive, the scope of the invention encompassing all changes which come within the meaning and range of equivalency of the above description and are therefore intended to be embraced therein.

We claim:

1. A modular specimen container comprising:
a base to stabilize the modular specimen container, walls removable attached to the base,
retaining means in the walls,
removable racks secured to the retaining means in the walls, a second retaining means on the removable racks for mating with the retaining means in the wall to allow for insertion and removal of the racks within the walls, and
securing means within at least the removable racks for retaining multiple specimen containers within the modular specimen container.

2. The modular specimen container of claim 1 wherein the removable racks have different size securing means for retaining multiple specimen containers.

3. The modular specimen container of claim 1 wherein the walls removable attached to the base contain a second securing means for securing one modular specimen container to a second modular specimen container.
